(19) United States
(12) Patent Application Publication
(10) Pub. No.: US 2022/0168084 A1
(43) Pub. Date: Jun. 2, 2022

(54) DRIVE MECHANISM FOR POWER DEVICE

(71) Applicant: Ranir, LLC, Grand Rapids, MI (US)

(72) Inventors: Bryan J. Dishon, Alto, MI (US); Patrick S. Sherer, Grand Rapids, MI (US)

(21) Appl. No.: 17/109,772

(22) Filed: Dec. 2, 2020

(51) Int. Cl. A61C 17/34; A61C 17/22

(52) U.S. Cl. CPC A61C 17/3481; A61C 17/221; A61C 17/225

(57) ABSTRACT

A drive mechanism for electric toothbrush includes a grip housing and a pivot housing mounted within the grip housing. The pivot housing has a fixed portion, a movable portion with a free end spaced from the fixed portion, and bridge that connects the fixed and movable portions and defines a fulcrum. A motor is mounted within the pivot housing, and an eccentric weight extends from the motor with the motor operable to rotate the eccentric weight. A brush shaft is attached to the pivot housing opposite the free end. A power source is adapted to activate the motor and rotate the eccentric weight, such that the free end of the pivot housing is driven to move by the movement of the eccentric weight, the pivot housing pivots at the fulcrum, and the brush end of the brush shaft oscillates about the fulcrum.

### BACKGROUND OF THE INVENTION

The present invention is directed to powered devices, and, more particularly, to powered devices such as an electric toothbrush drive unit.

One method for actuating the bristles, or other cleaning elements, of an electric toothbrush or another device having a powered handle is a drive mechanism positioned within the handle portion of the toothbrush or other device. These drive mechanisms generally convert energy from a motor into a desired movement of the bristles. The motor can be actuated by a switch to operate the drive mechanism.

There are a number of common drive mechanism styles. One style includes an electromagnetic drive, wherein the motor is operated to energize an electromagnet, and a movable permanent magnet (or a pair of permanent magnets) is positioned proximate to the electromagnet, such that the permanent magnet is driven to oscillate at an oscillating frequency by the electromagnet when the electromagnet is actuated. The electromagnetic drive unit generally results in a back-and-forth oscillating movement of the bristles.

Another common drive mechanism type is a gear drive. In gear drive mechanisms, the motor is operated to rotate a drive shaft, and a series of gears are connected between the drive shaft and a brush shaft to convert the motion of the brush shaft into a desired motion of the bristles. Gear driven mechanisms generally produce an oscillating rotational movement of the bristles.

Yet another known drive mechanism style includes the use of an eccentric weight. In this type of mechanism, the eccentric weight is connected to the motor drive shaft and positioned within a drive unit housing. Operation of the motor rotates the eccentric weight at a high speed, and causes vibration of the entire drive unit and bristles.

A workpiece, such as a brush head, for supporting the bristles or other cleaning elements is typically attached to the drive mechanism such that the workpiece is driven to move in a desired motion to by the movement of the respective drive mechanism. The workpiece generally includes a neck, which may be elongated, having a first end that is designed to attach to the drive mechanism, and a second end that supports a head and the cleaning elements. Recognizing the need to replace certain aspects of these workpieces, such as toothbrush bristles, after they are worn out or in order to provide more options, e.g., to attach a different head with a different function, manufacturers have designed these workpieces as replacement heads that fit onto separate drive units. The replacement heads can be removably attached to the drive units, for instance, by threading or otherwise connecting a portion of the replacement head onto a portion of the drive unit.

More recently, manufacturers have attempted to more efficiently control the movement of these workpieces, in order to provide a desirable workpiece motion that is cost effective to manufacture. For example, in the case of electromagnetic drive mechanisms, manufacturers have attempted to reduce the size and weight of the magnets in order to reduce costs and vibration within the handle. In the case of gear driven mechanisms, manufacturers have reduced and resized gears. Difficulties arise in these attempts, however, as small changes to the drive mechanisms can have a meaningful impact on the motion of the brush head, and on the motion conversion from the initial movement at the magnets or motor shafts to the desired movement at the bristles.

### SUMMARY OF THE INVENTION

The present invention provides a drive mechanism for a powered device that efficiently converts or translates the movement of a power source and motor into a desired movement of the workpiece. More particularly, the drive unit of the present invention uses a motor driven eccentric weight in combination with a pivot housing to provide a desired oscillating movement of the brush head.

In one embodiment, the drive mechanism includes a grip housing and a pivot housing mounted within the grip housing. The pivot housing has a fixed portion, a movable portion with a free end spaced from the fixed portion, and a fulcrum. A motor is mounted within the pivot housing, and an eccentric weight extends from the motor with the motor operable to rotate the eccentric weight. A brush shaft is attached to the pivot housing opposite the free end. The brush shaft extends along the longitudinal length of the grip housing and beyond one end of the grip housing, the brush shaft having a handle end mounted to the pivot housing and a brush end opposite the handle end, the brush end adapted to receive a toothbrush head with a plurality of cleaning elements. A power source is adapted to activate the motor and rotate the eccentric weight, such that the free end of the pivot housing is driven to move by the movement of the eccentric weight, the pivot housing pivots at the fulcrum, and the brush end of the brush shaft oscillates about the fulcrum.

In one embodiment, a motor shaft extends from the motor, and when the motor is activated, the motor shaft and the eccentric weight rotate about a motor axis that is parallel to the longitudinal length of the grip housing.

In another embodiment, the fulcrum is positioned between the fixed portion of the pivot housing and the free end. The pivot housing may include a circumferential outer wall section and a circumferential inner wall section, the inner wall section spaced from and positioned within the outer wall section, the outer wall section and the inner wall section connected by a bridge, wherein the bridge forms the fulcrum for the pivoting of the pivot housing. The bridge may include one or more bridge segments that twist in torsion as the pivot housing pivots. The bridge segments may be aligned, and may extend along a diameter of the outer wall section and the inner wall section, with the pivot housing further defining a first gap between the outer wall section and the inner wall section on a first side of the bridge and a second gap between the outer wall section and the inner wall section on a second side of the bridge. The first gap and the second gap may be at least partially filled with a thermoplastic elastomer to fill and seal the gaps but enable the twisting of the bridge segments.

The grip housing may include an open mouth at one end and a closed second end, with the pivot housing mounted adjacent to the open mouth to substantially close off the open mouth. In one embodiment, a cap is connected to the pivot housing and over the open mouth to seal the pivot housing within the grip housing. The fixed portion of the pivot housing may be designed to fixedly attach to the grip housing. In one embodiment, the outer wall section of the pivot housing includes structure adapted to snap fit into the open mouth of the grip housing.

In one embodiment, the pivot housing is at least partially enclosed by a circuit board housing, wherein a printed circuit board is mounted to the circuit board housing and at least one switch is operably connected to the circuit board, the printed circuit board is electrically connected to the switch and the battery such that actuation of the switch by the user causes the motor to rotate at a speed and time as programmed.

The drive mechanism of the present invention provides an efficient, cost effective method for providing oscillating side-to-side movement of a brush head without the need for springs, gears or magnets. The characteristics of the drive motion can be tuned with small alterations to the bridge segments, and the speed and timing of operation can be programmed via the printed circuit board as desired for a particular tooth brushing application.

The drive mechanism of the present invention efficiently converts or translates rotational movement of a drive shaft and eccentric weight into a desired back-and-forth movement of the workpiece, such as a brush head. The pivot housing enables such a conversion without the need for springs, magnets, or a complex gearing arrangement.

### BRIEF DESCRIPTION OF THE DRAWINGS

FIG. 1 is a perspective view of an electric toothbrush including a spring mechanism according to one embodiment of the present invention.

FIG. 2 is a cross sectional view thereof taken along line II-II in FIG. 1.

FIG. 3A is a close up front cross sectional view of a first portion of the electric toothbrush taking along line II-II.

FIG. 3B is a close up front cross sectional view of a second portion of the electric toothbrush taken along line II-II.

FIG. 4 is a front view of a portion of the electric toothbrush with a portion of the grip housing shown transparent to provide viewing of the internal components.

FIG. 5 is a front view of a portion of the spring mechanism according to one embodiment,

FIG. 6 is a top view of the spring mechanism.

FIG. 7 is a side view of the spring mechanism according to one embodiment.

FIG. 8 is a front perspective view of a portion of the power toothbrush with a portion of the grip housing removed to provide viewing of the internal components.

### DETAILED DESCRIPTION OF THE CURRENT EMBODIMENTS

I. Overview

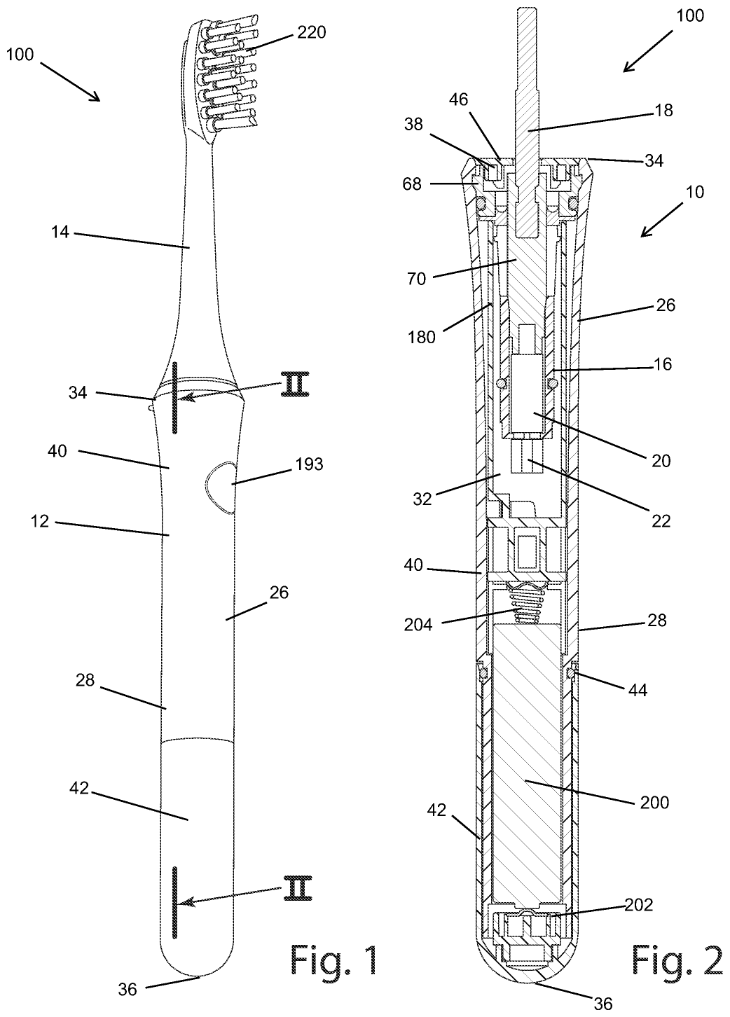

A drive mechanism for use in powered devices such as an electric toothbrush is shown in FIGS. 1-8 and generally designated 10. FIGS. 1 and 2 show one embodiment of an electric toothbrush 100 for use with the drive mechanism 10. The electric toothbrush 100 generally includes a handle or drive unit 12 and a replacement brush head 14. A pivot housing 16 is positioned within the drive unit 12, and a brush shaft 18 extends from the pivot housing 16 to form an attachment point for the replacement brush head 14. The pivot housing 16 houses a motor 20 that drives an eccentric weight 22. A portion of the pivot housing 16 forms a fulcrum 24. In operation, the motor 20 can be activated to drive the eccentric weight 22 and pivot the pivot housing 16 and the brush shaft 18 about the fulcrum 24 in the manner of a seesaw to drive the brush head 14 in a desired motion.

II. Structure

The drive unit 12 includes a grip housing 26 that forms an exterior shell of the drive unit 12. The grip housing 26 has an exterior surface 28 forming a grip surface for a user, and an interior surface 30 opposite the exterior surface and defining a hollow internal cavity 32. In one embodiment, the grip housing 26 is generally tubular, and in a more specific embodiment, the grip housing 26 is generally a cylindrical tube. The grip housing 26 includes a first end 34 and a second end 36 opposite the first end 34. In the illustrated embodiment, the cylindrical shape has a slight flare approaching the first end 34, and the first end 34 forms an opening or mouth 38. The grip housing 26 has a second end 36 opposite the first end, and in the illustrated embodiment the second end 36 is rounded and closed. The grip housing 26 may be formed from a variety of materials, but in the illustrated embodiment the grip housing 26 is formed from a molded thermoplastic, such as PVC. In the illustrated embodiment, the exterior grip surface 28 is generally smooth and rigid, but in another embodiment it may be formed from, or overlaid with, a tactile grip material such as a thermoplastic elastomer. In one embodiment, the grip housing 26 is a two piece housing, with a motor portion 40 including the first end 34, and a battery portion 42 including the second end 36. The battery portion 42 may be removable from the motor portion 40, for example, by a snap fit or a series of threads, for access to the internal cavity 32 and for battery replacement. As illustrated, the battery portion 42 snap fits to the motor portion and an elastomeric sealing ring 44 is positioned between the portions 40, 42 for preventing liquid or other debris from entering the internal cavity 32. The grip housing 26 defines a longitudinal axis 35 for the drive unit 12 extending centrally through the cylindrical grip housing 26 from the first end 36 to the second end 36.

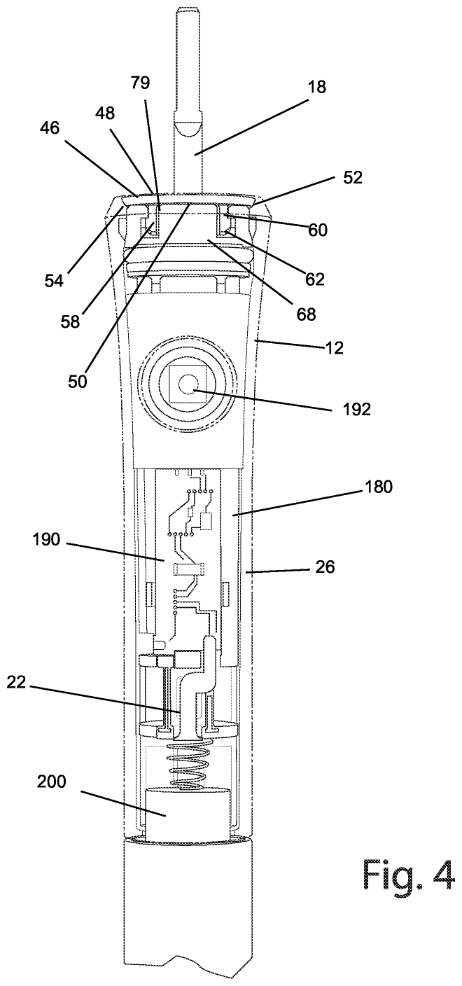

In one embodiment, a cap 46 is fitted into the mouth 38 of the grip housing 26 to cover the mouth 38 of the grip housing 26. Referring now to FIG. 4, the cap 46 includes an upper surface 48, a lower surface 50, and a circumferential edge 52. As illustrated, the cap 46 is sized such that the circumferential edge 52 seals against a rim 54 on the grip housing 26 that defines the mouth 38 of the grip housing 26. As shown, for example, in FIG. 7, the cap 46 may define a hole or opening 56 extending through the cap 46 for receiving the brush shaft 18. Referring again to FIG. 4, the cap 46 may also include a series of snap fingers 58 extending from the lower surface 50 for securing the cap 46 to the drive unit 12. The snap fingers 58 include a stem 60 extending from the lower surface 50, and a head 62 extending from the stem 60. The head 62 may be slightly larger in size than the stem such that a lower surface of the head 62 forms a surface to retain against a complimentary surface of the drive unit 12 as discussed in more detail below.

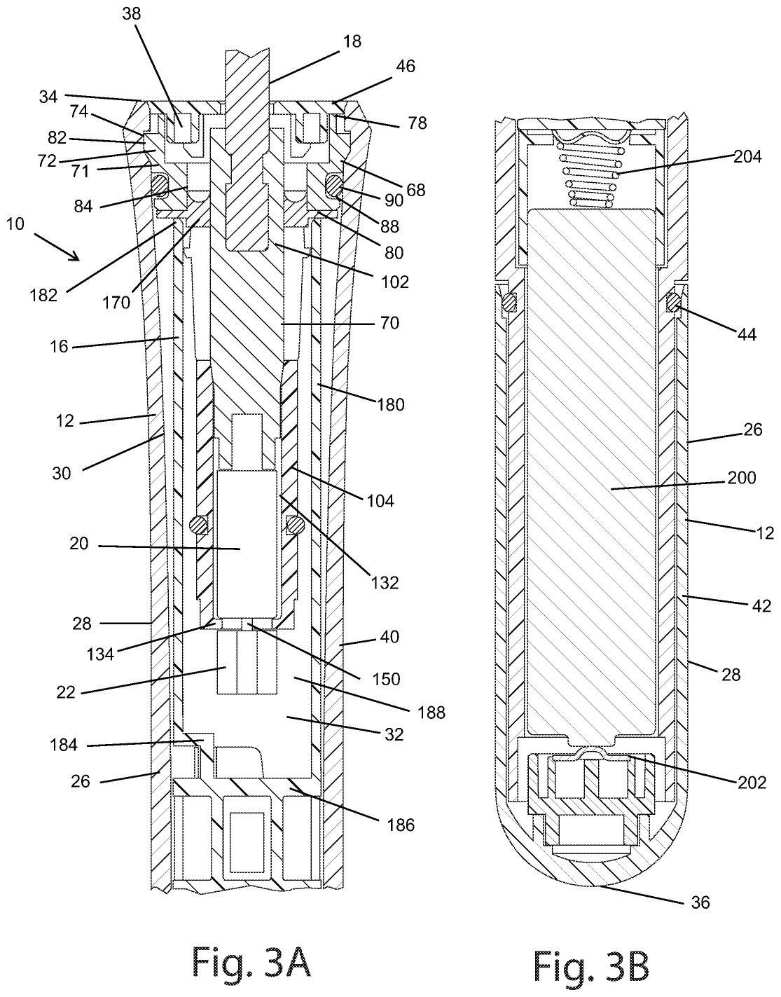

The pivot housing 16 is positioned within the interior cavity 32 of the grip housing 26 adjacent to the mouth 38 of the grip housing 26. In one embodiment, the pivot housing 16 includes an outer, fixed housing 68 and a central, pivoting housing 70. The outer housing 68 is fixed within the grip housing 26, whereas the central housing 70 is spaced inside the outer housing 68 and movable with respect to the outer housing 68 and grip housing 26 as described in more detail below. More particularly, the outer housing 68 has a sidewall 71 with a diameter that generally fits tightly within and against the inner surface 30 of the grip housing 26. Referring to FIG. 3A, the sidewall 71 includes a height defined between an upper end 78 and a lower end 80. The sidewall 71 further includes an outer surface 82 that engages the inner surface 30 of the grip housing 26, and an inner surface 84 opposite the outer surface 82. The outer surface 82 may include a pair of outwardly projecting detents 72 that interfit with corresponding recesses 74 in the inner surface 30 of the grip housing 26 adjacent the upper end 34 such that the pivot housing 16 is retained within the grip housing 26. In one embodiment, shown in FIG. 4, the upper end 78 defines a series of L-shaped recesses 79 for receiving the snap fingers 58 on the lower surface 50 of the cap 46, wherein the head 62 of each snap finger 58 engages a lower surface of the associated recess 79 for retaining the cap 46 on the drive unit 12. Referring again to FIG. 3A, the outer surface 82 of the sidewall 71 may additionally define an annular channel 88 extending around the circumference of the sidewall 71. As illustrated, a flexible sealing ring 90 is disposed in the channel 88 between the outer surface 82 and the inner surface 30 of the grip housing 26 to provide a seal therebetween. The fit and structure of the sidewall 71 and the inner surface 30 of the grip housing 26 act to laterally and axially retain and seal the outer housing 68 within the grip housing 26.

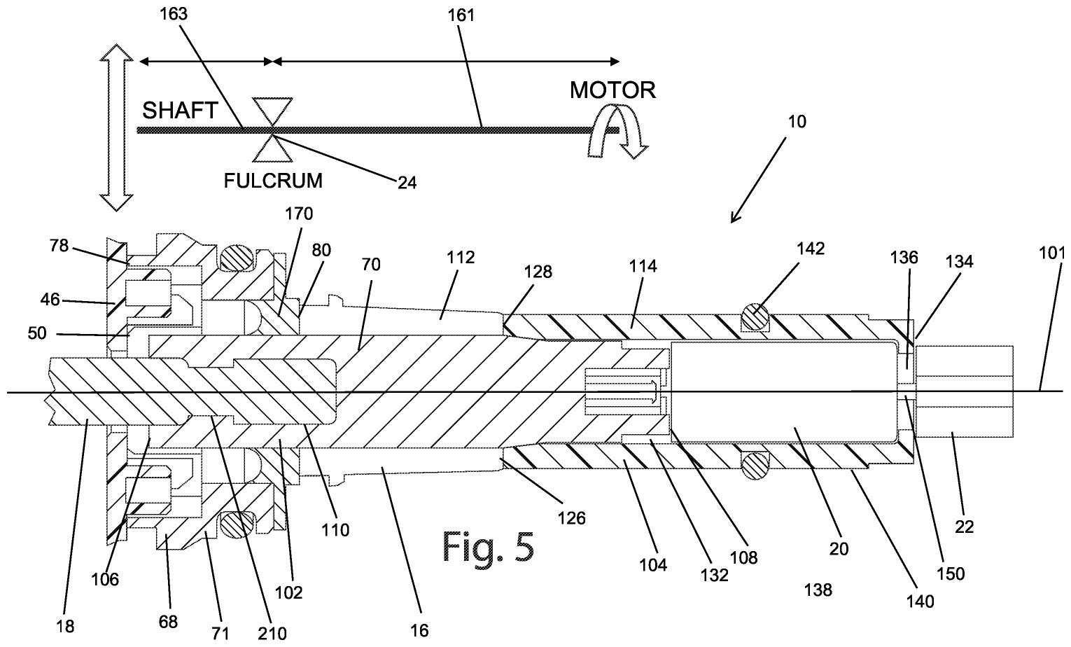

Referring to FIGS. 5-7, the central housing 70 extends along the longitudinal axis 101 of the grip housing 26 (represented by line 101 in FIG. 5), and includes a sleeve portion 102 and a motor housing portion 104. The sleeve 102 forms an upper portion of the central housing 102 and the motor housing 104 forms a lower portion. In one embodiment, the sleeve 102 is generally cylindrical, spaced from, and concentrically disposed within the outer housing 68. The sleeve 102 includes an upper end 106 and a lower end 108. The upper end 106 defines a central, longitudinally extending recess 110 extending along the longitudinal axis 101. As described in more detail below, the brush shaft 18 extends into and is secured in the recess 110. In the illustrated embodiment, the upper end 106 of the central housing 102 is spaced slightly below the upper end 78 of the outer housing 68 and the bottom surface 50 of the cap 46. In one embodiment, the recess 110 extends slightly below the lower end 80 of the outer housing 68, and the second end 108 of the sleeve 102 extends beyond the recess 110.

The motor housing portion 104 of the central housing 70 houses the motor 20. In the illustrated embodiment, the motor housing 104 is a two piece housing, with an upper section 112 and a lower section 114 that snap together to house the motor 20. The upper section 112 is a generally cylindrical, tubular section that extends around the part of the sleeve 102 that is immediately below the outer housing 68. The upper section 112 has an open lower end 126. Similar to the upper section 112, the lower section 114 may be a generally cylindrical, tubular section. The lower section 114 may have an open upper end 128, and at least one opening 130 that aligns and receives a corresponding detent 124 in the sleeve 102 such that the upper section 112 and lower section 114 can together to define an internal cavity 132. As shown, for example, in FIGS. 5-7, the lower section 114 may have a lower wall 134 that defines a drive shaft opening 136. In one embodiment, the lower section 114 includes an annular notch 138 on its exterior surface 140. The notch 138 receives a flexible ring 142, which may reduce noise as the pivot housing 16 pivots as described in more detail below.

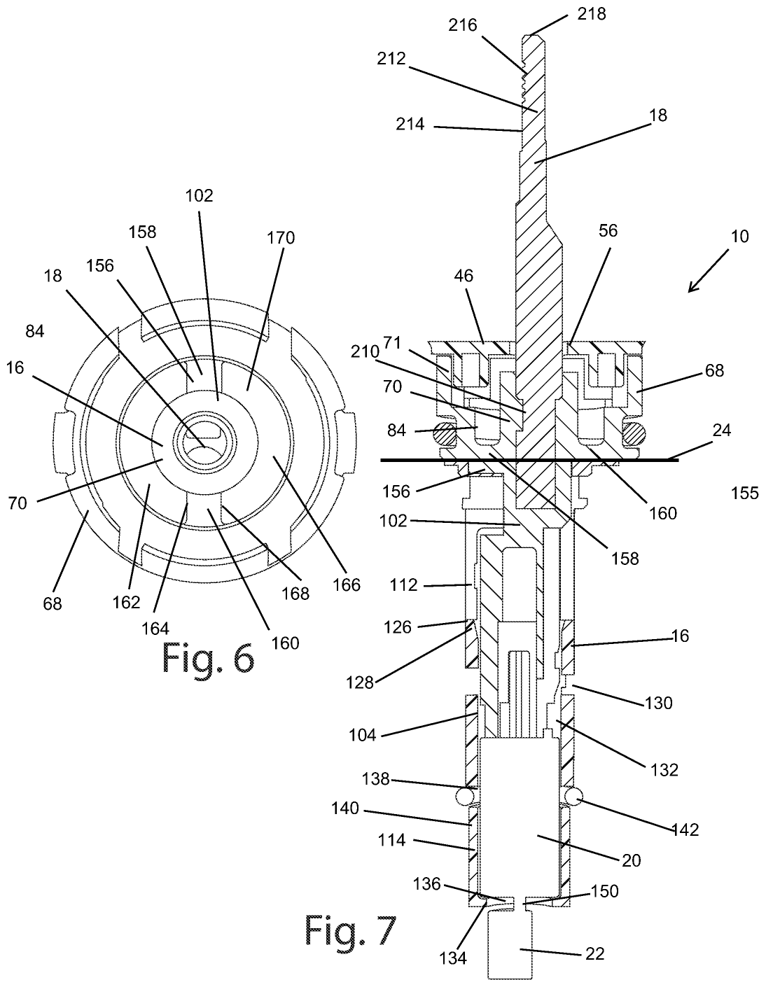

Notably, the outer housing 68 and the central housing 70 of the pivot housing 16 are connected to one another, and the location of such connection forms a fulcrum 24 for pivoting of the pivot housing 16. FIGS. 6 and 7 illustrate top and side views respectively of the structure of the fulcrum 24 according to one embodiment, and FIG. 5 shows a front view with a diagram of the movement of the pivot housing 16 about the fulcrum 24 in the manner of a seesaw. As the eccentric weight 22 rotates, the resulting torque causes movement of a first moment arm 161 (extending between the fulcrum 24 and the end 134 of the motor housing 104), and a second moment arm 163 (extending between the fulcrum 24 and the tip 218 of the brush shaft 14) about the fulcrum 24. As shown in FIGS. 6 and 7, the outer housing 68 and the central housing 70 are connected via a bridge 156 extending between the inner surface 84 of the sidewall 71 and the sleeve 102 of the central housing 70. More particularly, the bridge 156 is formed by a pair of bridge segments 158, 160, with a first bridge segment 158 extending between the sleeve 102 and a first portion of the inner surface 84 of the sidewall 71, and a second bridge segment 160 extending between the sleeve 102 and a second portion of the inner surface 84 of the sidewall 71. In the illustrated environment, the first 158 and second 160 bridge segments extend along a diameter of the outer housing 68 and the central housing 70, such that the first 158 and second 160 bridge segments are aligned with one another along the diameter. As a result, a pivot axis 155 is formed extending along a line through the bridge segments 158,160, whereby movement of the central housing 70 with respect to the fixed outer housing 68 is directed into pivoting movement of the central housing 70 about the pivot axis 155 (and thus fulcrum 24). The movement is directed in the manner of a seesaw with moment arms 161, 163, with the bridge segments 158, 160 twisting simultaneously in torsion as the central housing 70 pivots as a result of the rotational movement of the eccentric weight 22. As further shown in FIG. 6, a first gap 162 is formed between the outer housing 68 and the central housing 70 on a first side 164 of the bridge segments 158, 160, and a second gap 166 is formed between the outer housing 68 and the central housing 70 on a second side 168 of the bridge segments 158, 160 opposite the first side. In the illustrated embodiment, both of the gaps 162, 166 are C-shaped and are mirror images of each other on opposing sides 164, 168 of the bridge 156. Referring now to FIGS. 3A and 5, in one embodiment a flexible material 170, such as a thermoplastic elastomer, is provided in the gaps 162 and 166. The flexible material fills and seals the gaps 162, 166 without restricting the pivoting movement of the central housing 70 about the fulcrum 24 formed by the bridge 156. The combination of the bridge 156, which may be formed integrally with the pivot housing 16, gaps 162, 166, and elastomer 170, combine to focus, or direct, the pivoting of the pivot housing 16 in a desired direction, such as the direction of the arrow in FIG. 5.

The motor 20 is positioned within the interior cavity 132 in the motor housing 104. In one embodiment, the motor 20 is a DC motor including a motor shaft 150 and an eccentric weight 22 attached to the motor shaft 150 such that activation of the motor 20 will rotate the motor shaft 150 and the eccentric weight 22 at a desired speed, causing a vibratory movement at the location of the eccentric weight 22. As shown in FIG. 3A, for example, in the illustrated embodiment, the motor 20 is positioned within the interior cavity 132 of the motor housing, whereas the motor shaft 150 extends through the drive shaft opening 136 in the lower wall 134 of the lower motor housing section 114. The eccentric weight 22 is positioned outside of the motor housing 104 on an opposite side of the lower wall 134.

In one embodiment, a circuit board housing 180 is positioned in the grip housing 26 between the grip housing 26 and the pivot housing 16. With reference to FIG. 3A, the circuit board housing 180 is generally cylindrical with an open first end 182 and a closed second end 184. The first end 182 abuts the lower end 80 of the outer pivot housing 68 and the second end includes a wall 186 that is spaced from the eccentric weight 22 to provide room for the rotation and operation of the eccentric weight 22. The diameter of the circuit board housing 180 is such that the second end 184 fits tightly within the grip housing 26, whereas the outward flare of the grip housing 26 creates a slight gap between the grip housing 26 and the circuit board housing 180 at the first end 182 of the circuit board housing 180. Notably, the circuit board housing 180 is of sufficient diameter to create a gap 188 between the circuit board housing 180 and the central pivot housing 70 to provide room for movement of the central pivot housing 70 within the circuit board housing 180. Alternative sizes and shapes for the circuit board housing 180 may otherwise be used, however, such alternatives should provide clearance for movement of the central pivot housing 70.

Referring to FIG. 2, a power source, such as a battery 200 is positioned within the grip housing 26. More particularly, the battery 200 is positioned within the battery portion 42 of the grip housing 26. The battery 200 may be any cell type, including a rechargeable cell or a disposable battery. Positive 202 and negative 204 battery terminals are positioned within the battery portion 42 of the grip housing 26. As noted above, the battery portion 42 may be removable from the motor portion 40, for example, by a snap fit or a series of threads, for access to the internal cavity 32 and for replacement of the battery 200.

As shown in FIG. 4, a printed circuit board 190 is mounted on a portion of the circuit board housing 180. A switch 192 may be mounted within an opening in the grip housing 26, and the circuit board 190 may be connected in electrical communication with the switch 192, the motor 20 and the battery 200. A press of the switch 192 by a user thus activates the motor 20 to rotate the eccentric weight 22 as a function of the programming of the components of the printed circuit board 190. In one embodiment, the circuit board 190 is programmed to operate the motor 20 to rotate the motor shaft 150 and eccentric weight 22 in the range of about 14,000-17,500 rpm, and in one embodiment at about 15700 rpm at an input of 1.5 Volts DC. In another embodiment, the circuit board 190 may also be programmed to cycle through multiple speeds upon successive press of the switch 192. In yet another embodiment, the circuit board 190 may include a timer and may be programmed to operate the motor 20 for a predetermined period of time, of for multiple successive time periods. In one embodiment, the switch 192 is positioned directly beneath a button 193 positioned on the exterior of the grip housing 26 for operation by the user.

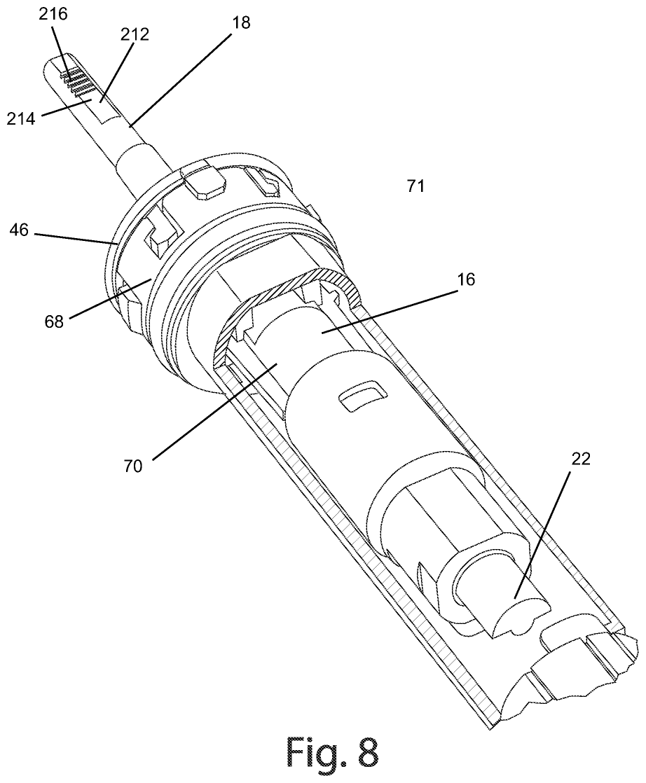

The brush shaft 18 is mounted to the pivot housing 16 such that the brush shaft 18 is movable with respect to the grip housing 26. The brush shaft 18 as illustrated is a straight shaft, generally comprised of metal or another rigid material, and extending along the longitudinal axis of the drive unit 12. In one embodiment, the brush shaft 18 is mounted in the recess 110 in upper end 106 of the sleeve 102. The sleeve 102 may be overmolded onto the brush shaft 18, or the brush shaft 18 may be attached within the recess by another method. As illustrated, the brush shaft 18 includes an annular recess 210 to prevent axial removal of the brush shaft 18 from the sleeve 102. The brush shaft 18 also includes structure to receive a replacement brush head 14. The brush head 14 generally includes a central bore or receptacle (not shown) that receives the brush shaft 18 for operation of the toothbrush 100. In one embodiment, the brush shaft 18 and receptacle are keyed to properly align the brush head 14 on the brush shaft 18. As shown in FIGS. 7 and 8, the brush shaft 18 is keyed by having an upper portion 212 that is provided with a D-shaped cross section when viewed longitudinally, creating a flat surface 214 on one side of the brush shaft 18. The flat surface 214 may further include a series of ridges 216 for frictionally engaging the brush head 14 to prevent axial removal of the brush head 14 from the brush shaft 18. The brush head 14 is similarly keyed, such that when attached to the brush shaft, the cleaning elements 220 (see FIG. 1) of the brush head 14 extend along a desired cleaning element direction. Other attachment methods, such as clips or springs, may otherwise be used to retain the brush head 14 on the brush shaft 18. In the illustrated embodiment, the flat surface 214 is positioned to face the forward surface of the toothbrush 100. Referring to FIG. 7, in this embodiment, the flat surface 214 is positioned to extend in a plane that is perpendicular to the pivot axis 155 about which the brush shaft 18 pivots. As illustrated, the brush head 14 includes a plurality of conventional bristles as cleaning elements 220. The bristles may be of various lengths extending outwardly from the brush head 14. In another embodiment, the brush head 14 may include one or more alternative cleaning elements, such as elastomeric elements, extending from the brush head 14.

Various characteristics of the drive mechanism 10 can be altered in order to control the movement of the brush head 14. For example, the lengths of the respective moment arms 161, 163 can be predetermined, and altered as desired, to provide a desired movement of the brush head 14. In one embodiment, the length of the second moment arm 163 is approximately 90-95% of the length of the first moment arm 161 to provide a desired side-to-side (and slightly arcuate) motion of the brush head 14. The lengths of the moment arms 161, 163, and the length of each moment arm 161, 163 with respect to the other, may be altered by the manufacturer as desired to produce greater or lesser movement of the second moment arm 161 (which is approximately the same as the movement of the brush head 14). In another embodiment, the characteristics of the bridge 156 and bridge segments 158, 160 can be altered to provide a desired movement. For example, the thickness or cross sectional geometry of the bridge segments 158, 160 can be changed in order to increase or decrease the amplitude and speed of the brush head 14 movement. In the illustrated embodiment, the bridge segments 158, 160 have a generally rectangular cross section, but may otherwise be provided with a square cross section, circular cross section, hexagonal cross section, or otherwise in order to provide the desired movement. In another embodiment, the stiffness of the elastomer 170 can be altered to provide a desired brush head 14 movement.

III. Operation

The toothbrush 100 is designed such that, in operation, the switch 192 can be actuated by a user to activate the motor 20 and oscillate the brush head 14 back and forth in a side-to-side motion by pivoting about the fulcrum 24 created by the pivot housing 16. The steps of operation are described below in more detail.

Initially, a user will attach a brush head 14 to the brush shaft 16 by inserting the brush shaft 18 into the central recess within the brush head 14. The keyed shape of the brush shaft 18 and brush head 14 acts to orient the brush head 14 with the cleaning elements 220 extending in a desired direction. In one embodiment, the cleaning elements 220 have cleaning element direction that extends generally perpendicular to the pivot axis 155 of the spring mechanism 10 as described in more detail below.

The toothbrush 100 is operated by a user by pressing the switch 192, whereby the battery 200 is electrically connected to the circuit board 190 and the motor 20. The motor 20 thus operates to rotate the motor shaft 150 and eccentric weight 22 at the speed and timing that has been programmed. The rotating motor shaft 150 is aligned with the longitudinal axis of the drive unit 10 (defined by the central axis of the grip housing 26), and the eccentric weight 22 is offset from the longitudinal axis, such that rotation of the eccentric weight causes an oscillating vibration at the location of the eccentric weight 22.

The oscillating vibration of the eccentric weight 22 is converted into side-to-side oscillation of the brush shaft 18 (and brush head 14) about the fulcrum 24 due to the structure of the pivot housing 16. In short, the pivot housing 16 has a fixed outer housing 68 and a movable central housing 70 that are connected to one another by a bridge 156. The bridge 156 forms the fulcrum point 24 for pivoting of the central housing 70 portion of the pivot housing 16, and controls the direction of oscillation via the orientation of the direction of the bridge 156 with respect to the grip housing 26 and the direction of the cleaning elements 220. In the specific embodiment illustrated, the bridge 156 is formed by a pair of bridge segments 158 that extend between a sleeve 102 of the central housing 70 and an inner surface 30 of the outer housing 68. The bridge segments 158 align with each other along a diameter of the grip housing 26, outer housing 68 and central housing 70, with each bridge segment 158 extending from an opposite side of the sleeve 102 to the inner surface 84 of the outer housing 68. The direction of the bridge segments 158 and bridge 156 sets the orientation the pivot axis 155 in a desired direction, which in the illustrated embodiment is a direction perpendicular to the flat surface 214 of the brush shaft 18. As a result, operation of the motor 20 and the oscillatory vibration of the eccentric weight 22 causes pivoting of the central housing 70 in a generally back-and-forth oscillating movement about the bridge 156, such that the bridge segments 158 twist together in torsion about the pivot axis 155 and the central housing 70 pivots about the pivot axis 155 in the manner of a seesaw. The direction of the movement of the motor housing 104 would be generally up and down as illustrated in FIG. 5 and generally in and out of the page in the orientation shown in FIG. 7. The brush shaft 18 moves in the same back-and-forth direction as the motor housing 104, but as a result of the central housing 70 pivoting at the bridge 156, the movement of the brush shaft 18 will be opposite the movement of the motor housing 104. Notably, although the movement of the brush head 14 and cleaning elements 220 is described herein as oscillating “side-to-side” or “back and forth,” the path of movement is also slightly arcuate as the movement is defined by the pivoting of the pivot housing 16 and brush shaft 18 about the fulcrum 24.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A drive mechanism for an electric toothbrush comprising:
a grip housing having a first end and a second end and defining a longitudinal length between the first and second ends;
a pivot housing mounted within the grip housing, the pivot housing having a fixed portion, a free end spaced from the fixed portion, and a fulcrum;
a motor mounted within the pivot housing, and an eccentric weight extending from the motor, the motor operable to move the eccentric weight;
a brush shaft extending along the longitudinal length of the grip housing and beyond the first end of the grip housing, the brush shaft having a handle end mounted to the pivot housing and a brush end opposite the handle end, the brush end adapted to receive a toothbrush head with a plurality of cleaning elements; and
a power source adapted to activate the motor and move the eccentric weight, such that the free end of the pivot housing is driven to move by the movement of the eccentric weight, the pivot housing pivots about the fulcrum, and the brush end of the brush shaft oscillates about the fulcrum.

2. The drive mechanism of claim 1 wherein a motor shaft extends from the motor, and wherein when the motor is activated, the motor shaft and the eccentric weight rotate about a motor axis that is parallel to the longitudinal length of the grip housing.

3. The drive mechanism of claim 2 wherein the fulcrum is positioned between the fixed portion of the pivot housing and the free end.

4. The drive mechanism of claim 3 wherein the pivot housing includes a circumferential outer wall section and a circumferential inner wall section, the inner wall section spaced from and positioned within the outer wall section, the outer wall section and the inner wall section connected by a bridge, wherein the fulcrum is positioned at the bridge.

5. The drive mechanism of claim 4 wherein the bridge defines a thickness and extends along a diameter between the outer wall section and the inner wall section, the pivot housing defining a first gap between the outer wall section and the inner wall section on a first side of the bridge and a second gap between the outer wall section and the inner wall section on a second side of the bridge.

6. The drive mechanism of claim 5 wherein the first gap and the second gap are at least partially filled with a thermoplastic elastomer.

7. The drive mechanism of claim 6 wherein the power source is a battery housed within the grip housing.

8. The drive mechanism of claim 7 wherein the grip housing includes an open mouth at the first end and a closed second end, the pivot housing mounted adjacent to the open mouth and substantially closing the open mouth.

9. The drive mechanism of claim 8 wherein the outer wall section of the pivot housing includes structure adapted to snap fit into the open mouth of the grip housing.

10. The drive mechanism of claim 9 wherein the pivot housing is at least partially enclosed by a PCB housing, wherein a printed circuit board is mounted to the PCB housing and at least one switch is operably connected to the printed circuit board, the printed circuit board electrically connected to the switch and the battery.

11. A drive mechanism for an electric appliance, comprising:
a tubular grip housing having a first end and a second end and defining a longitudinal length between the first and second ends;
a pivot housing mounted within the grip housing, the pivot housing having a fixed portion and a free end, the free end spaced from the grip housing such that the free end is movable within the grip housing;
a motor mounted within the pivot housing, and an eccentric weight extending from the motor, the motor operable to rotate the eccentric weight about a motor axis that extends parallel to the longitudinal length of the grip housing;
a brush shaft extending along the longitudinal length of the grip housing and beyond the first end of the grip housing, the brush shaft having a handle end mounted to the pivot housing and a brush end opposite the handle end, the brush end adapted to receive a toothbrush head having a plurality of cleaning elements; and
a power source within the grip housing adapted to activate the motor and rotate the eccentric weight, such that the free end of the pivot housing is driven to move by the movement of the eccentric weight, wherein a portion of the pivot housing bends about a pivot axis that is perpendicular to the motor axis, and the brush end of the brush shaft oscillates about the pivot axis.

12. The drive mechanism of claim 11 wherein the pivot axis is positioned between the fixed portion and the motor.

13. The drive mechanism of claim 12 wherein the pivot housing is a tubular housing having an outer wall and a concentric inner wall spaced from and inside of the outer wall, the outer wall forming the fixed portion of the pivot housing, the inner wall connected to the outer wall by a bridge extending between the inner and outer walls, the pivot axis extending through the bridge such that the free end of the pivot housing bends with respect to the fixed potion about the bridge.

14. The drive mechanism of claim 13 wherein the bridge extends along only a diameter of the pivot housing.

15. The drive mechanism of claim 14 wherein the pivot housing defines a first gap between the outer wall and the inner wall on a first side of the bridge and a second gap between the outer wall and the inner wall on a second side of the bridge.

16. The drive mechanism of claim 15 wherein the first and second gaps are filled with a flexible thermoplastic elastomer.

17. The drive mechanism of claim 16 wherein the thermoplastic elastomer within the first gap and the thermoplastic elastomer in the second gap are opposingly compressed as the pivot housing pivots about the pivot axis.

18. The drive mechanism of claim 17 wherein the pivot housing includes a motor housing portion spaced from the outer wall and the inner wall along the longitudinal length of the grip housing, the motor positioned within the motor housing.

19. The drive mechanism of claim 18 wherein the handle end of the brush shaft is molded into the inner wall of the pivot housing.

20. A method for operating an electric toothbrush drive mechanism, comprising:
providing a tubular grip housing having a first end and a second end and defining a longitudinal length between the first and second ends;
inserting a pivot housing within the grip housing, the pivot housing having a fixed portion, a free end and a pivot axis between the fixed portion and the free end, the fixed portion engaging the grip housing, the free end spaced the grip housing;
a motor mounted within the pivot housing, and an eccentric weight extending from the motor on a motor shaft that extends parallel to the longitudinal length of the grip housing;
mounting a brush shaft along the longitudinal length of the grip housing, the brush shaft having a handle end mounted to the pivot housing and a brush end opposite the handle end, the brush end adapted to receive a toothbrush head having a plurality of cleaning elements; and
operating the motor to rotate the eccentric weight, such that the free end of the pivot housing is driven to move within the grip housing by the movement of the eccentric weight, wherein a portion of the pivot housing bends about the pivot axis and the brush end of the brush shaft oscillates about the pivot axis.
